(19) United States
(12) Patent Application Publication
(10) Pub. No.: US 2013/0033002 A1
(43) Pub. Date: Feb. 7, 2013

(54) Spark Plug Chess Set Construction

(71) Applicant: Kenneth Marx, Helena, MT (US)

(72) Inventor: Kenneth Marx, Helena, MT (US)

(21) Appl. No.: 13/558,473

(22) Filed: Jul. 26, 2012

Related U.S. Application Data
(60) Provisional application No. 61/515,370, filed on Aug. 5, 2011.

(51) Int. Cl. A63F 3/02; B23P 15/00

(52) U.S. Cl. 273/291; 29/401.1

(57) ABSTRACT

Disclosed is a chess set piece construction that utilizes a spark plug body, a weighted hardware attachment as a base and a decorative hardware attachment for an upper adornment that signifies the piece type. A repurposed or recycled spark plug is utilized as the chess piece body structure, wherein the lower threading above an electrode, a socket driver hex midsection, and the elongated insulator section is retained in the finished piece, while the terminal may be removed in certain embodiments. A weighted mechanical nut or similar piece of hardware is mated to the lower threading of the plug, while an upper, decorative portion is positioned in place of the terminal or therearound. The lower nut provides a stable base for the piece, the plug body provides the midsection structure, while the upper portion signifying the type of chess piece. The elements may be painted to signify opposing chess piece sides.

### CROSS REFERENCE TO RELATED APPLICATION

This application claims the benefit of U.S. Provisional Application No. 61/515,370 filed on Aug. 5, 2011, entitled “Sparkplug Chess Set.” The patent application identified above is incorporated here by reference in its entirety to provide continuity of disclosure.

### BACKGROUND OF THE INVENTION

1. Field of the Invention

The present invention relates to board games and game piece construction. More specifically, the present invention pertains to a new and unique construction for chess pieces utilizing repurposed or recycled spark plugs originally designed for a reciprocating engine.

Chess is a popular board game played around the world and involves two opposing teams of game pieces having unique characteristics and freedom of movements across the chess board. The number of each piece and the types of each piece are critically important for game play, as the more freely moving pieces are less prevalent than the more restricted game pieces. Signifying each game piece type and the overall style of the two sides of pieces has been a source of great artistic diversity and a means for users to personalize their game of chess. Pieces can be formed from chiseled and polished wood or stone, or further the pieces may take the look of a certain era or battleground.

Chess pieces of varying construction have been disclosed, as unique styles and methods of creating interesting looking or functional pieces were developed to add flare and personalization to the game. The present invention pertains to a new and unique chess piece construction, wherein a reciprocating engine spark plug is recapitalized, repurposed or reused to create the body of the chess pieces and a means to attach a weighted base. The spark plugs are modified and the adornments are fabricated onto the plug to create the unique chess characters: the king, queen, bishop, knight, rook and pawn. The weighted base improves stability of the piece, while the use of spark plugs is a recycling method that reduces waste and adds individualization to the game, specifically for those mechanically inclined or those what an affinity for automotive products.

2. Description of the Prior Art

Devices have been disclosed in the prior art that relate to chess game piece construction. These include devices that have been patented and published in patent application publications, and generally relate to the use of hardware for creating chess pieces and properly weighting the pieces for stable positioning and movement. The forgoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 5,486,004 to Fogarty discloses a chess set wherein each chess set member is a statuesque piece having a symbol that displays a relevant decorative indication of the respective piece's entitled moves or degrees of freedom on the chess board surface. The indicators are extensions formed from a central point on the decorative piece, wherein the extensions are directed to the relevant linear moves of the piece, including left, right, forward, back, and diagonal for all pieces other than a knight, which is provided a relative L-shape for its move. The indicator extensions span along a vertical plane for visibility of a user operating the chess pieces. The Fogarty device provides a uniquely decorated chess set that is both ornamental and functional, providing new and learning users with readily visible references for determining a given chess piece degrees of freedom on the chess board surface. The present invention, by contrast, disclose a new and novel means of chess piece construction utilizing repurposed or recycled spark plugs as a structure for building unique chess pieces for each chess character.

Further, U.S. Pat. No. 6,513,809 to Graff is another such device that discloses the use of mechanical hardware as a means of constructing chess set pieces. The pieces comprise a central shaft having threading and a cylindrical structure to accept mechanical nuts and holed components to form the decorative or differentiating base and upper portion of the chess piece. The holed components have a central through-hole through which the central shaft projects through, after which a nut is stacked thereover to secure the holed component and the assembly as a static article for game play. Different nuts and holed components are utilized to form individual pieces that comprise a full chess set. The Graff device, while disclosing a unique construction for a set of chess pieces, fails to disclose the use of spark plug assemblies as the primary means of forming the body structure of each piece. The present invention utilizes a spark plug for form each piece, which is particularly suited for those with automotive interests, those wishing for a unique chess set construction or those with left over spark plugs from reciprocating engine servicing.

The present invention provides a new chess set construction that utilizes spark plugs rather than generic mechanical hardware or solid, machined pieces. The pieces share the same spark plug body and base, however the upper adornments reveal the piece type and its overall paint scheme tells one side from the other during competition. It is submitted that the present invention substantially diverges in design elements from the prior art and consequently it is clear that there is a need in the art for an improvement to existing chess set constructions. In this regard the instant invention substantially fulfills these needs.

### SUMMARY OF THE INVENTION

In view of the foregoing disadvantages inherent in the known types of chess set constructions now present in the prior art, the present invention provides a new chess set construction utilizing a reciprocating engine spark plug and attachment hardware.

It is therefore an object of the present invention to provide a new and improved chess set construction that has all of the advantages of the prior art and none of the disadvantages.

It is another object of the present invention to provide a chess set construction that utilizes repurposed or recycled spark plugs as a body structure for a chess set, wherein the insulator, hex nut and threading are utilized for the body of each piece and a weighted hardware base and upper adornment are further added.

Another object of the present invention is to provide a chess set construction that utilizes a weighted hardware base that threadably attaches to the threads of the spark plug body section.

Yet another object of the present invention is to provide a chess set construction that is attractive for automotive enthusiasts and mechanical people, wherein an engine component is repurposed or recycled.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of a member of the present invention chess set.

FIG. 2 shows a perspective view of an embodiment of a member of the present invention chess set.

FIG. 3 shows another perspective view of an embodiment of a member of the present invention chess set.

FIG. 4 shows the complete chess set in a deployed state situated on a chess board.

### DETAILED DESCRIPTION OF THE INVENTION

Reference is made herein to the attached drawings. Like reference numerals are used throughout the drawings to depict like or similar elements of the spark plug chess set construction. For the purposes of presenting a brief and clear description of the present invention, the preferred embodiment will be discussed as used for providing a new and unique means of constructing chess game pieces. The figures are intended for representative purposes only and should not be considered to be limiting in any respect.

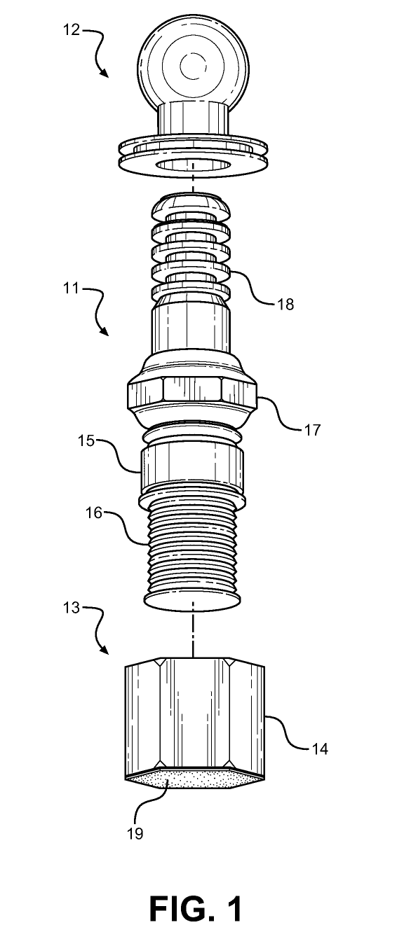

Referring now to FIG. 1, there is shown an exploded perspective view of an embodiment of the present invention. The device is a chess piece construction having a spark plug body section 11, a weighted base 13 and an upper adornment 12 that signifies the piece type within the chess set. A repurposed or recycled spark plug, wherein the plug was previously unused or previously utilized as a reciprocating engine spark generator, respectively, is utilized as the body structure 11 of the game pieces. The spark plug insulator section 18 forms the upstanding portion of the body 11, while a hex nut 17 separates the plug midsection 15 and threading portion 16. The electrode is removed from the base of the threading 16, while a hardware nut 14 is threaded thereon to create a weighted base member 13. The weighted base 13 supports the upstanding game piece and prevents it from readily tipping during game play, and further adds mass to the overall piece for better handling and feel. The lower surface 19 of the base may further include a felt covering to prevent scratching of the chess board surface. The top of the spark plug body 11 includes a removed terminal, wherein the insulator 18 terminates at a shelf for accepting an upper adornment 12. The adornment 12 is one that signifies the type of piece and therefore the degrees of freedom for the specific piece. The overall height of the insulator 18 is further adjustable to create shorter pawns (FIG. 3) and intermediate sizes for different game pieces.

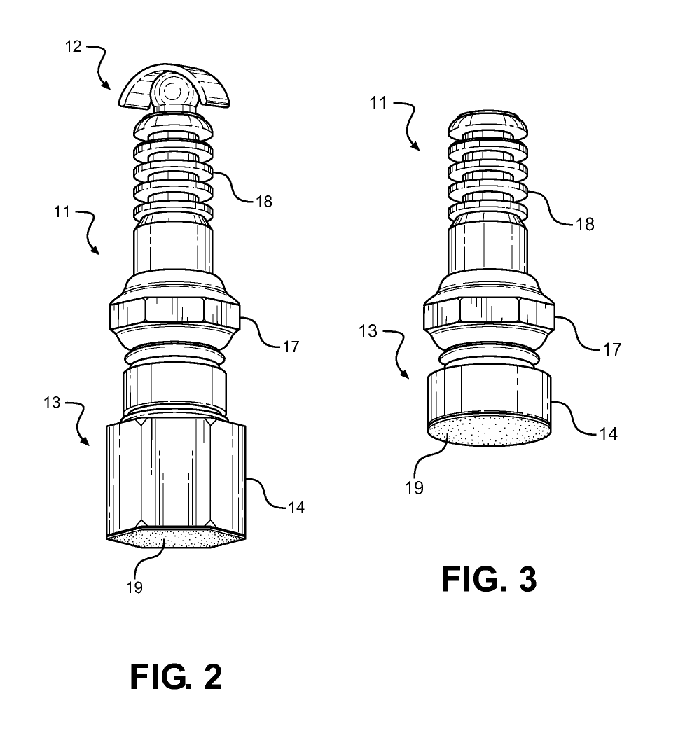

Referring now to FIGS. 2 and 3, there are shown two embodiments and styles of the chess piece construction of the present invention, wherein a knight (FIG. 2) and a pawn (FIG. 3) are visualized. In the knight embodiment, the upper adornment 12 is one of modest complexity, while the pawn is one having no upper adornment whatsoever, denoting its lower stature within the chess hierarchy. However, both pieces, as well as all pieces in the set, include a spark plug body section 11 and a threaded lower section connected to a weighted base 13. The body of the spark plug, as well as the adornments 12 and base 13 may be painted or decorated to establish affiliation of the chess pieces to one side or another during play.

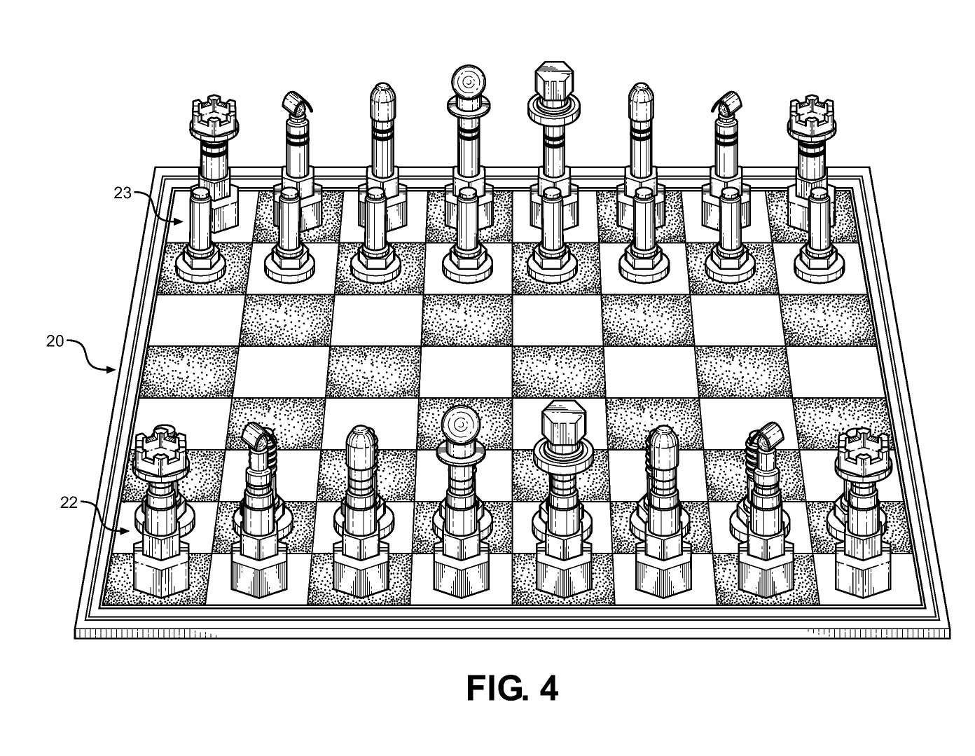

Referring now to FIG. 4, there is shown an overhead perspective of an entire chess set utilizing the disclosed construction, wherein the set contains two complete sides 22, 23 for proper chess play on a chess board surface 20. As is customary, the king and queen represent the most lavish and decorative features to denote their importance and higher position over the other pieces. These pieces include highly visible and generally taller upper adornments, which may include other mechanical hardware that is attached to the upper portion of the spark plug body. For the rook pieces, a castle nut may be affixed to the upper portion of the spark plug body to show a castle tower, bailey or keep shape that is characterized by the rook in most commonly available chess sets. The spark plug body section is of the same generic size and shape, while the base member is one that provides improved overall weight and stability of the pieces as a threaded nut attachment.

The pieces used in traditional chess sets are often made of wood and other lightweight materials formed or carved from a unitary material. While in use, these pieces may be easily knocked over, which may cause players to lose their places on the board and start over. The time and energy required to carefully place each piece back into its rightful position prior to be knocked over can be frustrating, if at all possible given the stage of the game. Additionally, the materials traditionally used to construct chess pieces may be susceptible to developing scratches, nicks, and chips, requiring users to purchase replacements. The present invention provides users with a uniquely-designed and durable alternative to a traditional chess set, and one that may be particularly suited for automotive or mechanical enthusiasts. The present invention features game pieces that utilize a spark plug body section for a core material, wherein the plugs may be repurposed, unused pieces of hardware, or alternatively a recycled item. The spark plugs may add a uniquely attractive appearance to each piece, while the construction may provide additional weight for keeping the pieces firmly planted on the board during play. The use of spark plugs is both attractive and environmentally friendly, as used spark plugs are generally discarded after use rather than recycled.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A chess piece construction, comprising:
a body section, a weighted base and an upper portion;
said body section comprising a repurposed or recycled spark plug having a lower threaded section and an upper insulator portion separated by a nut midsection;
said weighted base comprising a hardware nut threadably engaged on said spark plug lower threaded section.

2) The device of claim 1, wherein said spark plug further comprises standard reciprocating engine spark plug having a removed electrode and terminal.

3) The device of claim 1, wherein said chess piece upper portion further comprises an upper adornment to signify the significance of said chess piece type.

4) The device of claim 3, wherein said upper adornment for a rook piece comprises a castle nut.

5) The device of claim 1, wherein said chess piece pawn further comprises an insulator upper termination.

6) A method of constructing a chess piece, comprising the steps of:
obtaining a spark plug having a threaded base and an insulator body section;
removing said spark plug electrode and terminal;
threadably attaching a weighted nut to said threaded base;
attaching an upper adornment based on each piece type for a set for all pieces but pawns.

7) The method of claim 6, further comprising the steps of:
painting said spark plug, weighted nut and upper adornment based on a uniform pattern to signify a chess board side.
